(19) United States
(12) Patent Application Publication
(10) Pub. No.: US 2026/0162002 A1
(43) Pub. Date: Jun. 11, 2026

(54) MACHINE LEARNING MODEL FOR DETERMINING A ROOT CAUSE OF SPOT WELD SPATTER

(71) Applicant: TOYOTA RESEARCH INSTITUTE, INC., Los Altos, CA (US)

(72) Inventors: Matthew P. GORDON, Berkeley, CA (US); Pavel M. KONOV, San Francisco, CA (US); Christopher D. SYNOWIEC, Evansville, IN (US); Brandon HAIGHT, Elberfeld, IN (US)

(73) Assignees: TOYOTA RESEARCH INSTITUTE, INC., Los Altos, CA (US); TOYOTA JIDOSHA KABUSHIKI KAISHA, Aichi-Ken (JP)

(21) Appl. No.: 18/975,472

(22) Filed: Dec. 10, 2024

(51) Int. Cl. G06N 20/00; B23K 11/11; G06F 18/23

(52) U.S. Cl. CPC G06N 20/00; B23K 11/11; G06F 18/23

(57) ABSTRACT

A method for detecting spatter events in a resistance spot welding process includes collecting resistance time series data during a welding operation. The method also includes extracting features from the resistance time series data in both the time domain and frequency domain. The method further includes detecting, via a weld spatter model, spatter events by identifying deviations or anomalies within the resistance time series data, the weld spatter model trained in an unsupervised manner to identify patterns or clusters based on the extracted features. The method still further includes classifying, via the weld spatter mode, one or more causes of the spatter events based on detecting the spatter events.

### BACKGROUND

### Field

Aspects of the present disclosure generally relate to artificial neural networks, and more specifically to a machine learning model that determines a root cause of a spot weld pattern.

### Background

Resistance spot welding is a process used in manufacturing, particularly in the automotive industry, to join metal sheets together. Resistance spot welding involves clamping two or more overlapping metal sheets between copper alloy electrodes, which apply both pressure and an electrical current to the area being welded. The electrical current generates heat due to the resistance of the metal sheets, causing the metal at the contact points to melt and form a weld nugget. As the electrodes maintain pressure, the molten metal solidifies, creating a strong bond between the sheets.

During the resistance spot welding process, molten steel may be ejected from the welding area, resulting in weld spatter. The weld splatter may be a result of one or more factors, such as, but not limited to, improper welding parameters or misalignment. This weld spatter is undesirable as it adheres to surrounding surfaces, leading to costly cleanup and potential damage to the car body. Additionally, the expelled molten steel can cause surface defects such as pitting, burns, or rough spots, which may require additional repair work or even lead to parts being scrapped. Furthermore, weld spatter can affect the appearance and performance of the car body, impacting paint adhesion, corrosion resistance, and overall structural integrity. Therefore, it may be desirable to control and minimize weld spatter to maintain quality, reduce waste, and lower production costs.

### SUMMARY

In one aspect of the present disclosure, a method for detecting spatter events in a resistance spot welding process includes collecting resistance time series data during a welding operation. The method further includes extracting features from the resistance time series data in both the time domain and the frequency domain. The method also includes detecting spatter events using a weld spatter model by identifying deviations or anomalies within the resistance time series data, the weld spatter model being trained in an unsupervised manner to identify patterns or clusters based on the extracted features. The method still further includes classifying one or more causes of the spatter events based on detecting the spatter events.

Another aspect of the present disclosure is directed to an apparatus including means for collecting resistance time series data during a welding operation. The apparatus further includes means for extracting features from the resistance time series data in both the time domain and the frequency domain. The apparatus also includes means for detecting spatter events via a weld spatter model by identifying deviations or anomalies within the resistance time series data, the weld spatter model being trained in an unsupervised manner to identify patterns or clusters based on the extracted features. The apparatus further includes means for classifying one or more causes of the spatter events based on detecting the spatter events.

In another aspect of the present disclosure, a non-transitory computer-readable medium with non-transitory program code recorded thereon is disclosed. The program code is executed by a processor and includes program code to collect resistance time series data during a welding operation. The program code further includes program code to extract features from the resistance time series data in both the time domain and the frequency domain. The program code also includes program code to detect spatter events via a weld spatter model by identifying deviations or anomalies within the resistance time series data, the weld spatter model being trained in an unsupervised manner to identify patterns or clusters based on the extracted features. The program code still further includes program code to classify one or more causes of the spatter events based on detecting the spatter events.

Another aspect of the present disclosure is directed to an apparatus having a processor, and a memory coupled with the processor and storing instructions operable, when executed by the processor, to cause the apparatus to collect resistance time series data during a welding operation. Execution of the instructions further causes the apparatus to extract features from the resistance time series data in both the time domain and the frequency domain. Execution of the instructions also causes the apparatus to detect spatter events via a weld spatter model by identifying deviations or anomalies within the resistance time series data, the weld spatter model being trained in an unsupervised manner to identify patterns or clusters based on the extracted features. Execution of the instructions still further causes the apparatus to classify one or more causes of the spatter events based on detecting the spatter events.

Aspects generally include a method, apparatus, system, computer program product, non-transitory computer-readable medium, user equipment, base station, wireless communication device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram illustrating an example of a system for detecting weld spatter, in accordance with aspects of the present disclosure.

FIG. 2 is a diagram illustrating an example of a hardware implementation for a system for detecting weld spatter, in accordance with aspects of the present disclosure.

FIG. 3 is a diagram illustrating an example of a welding gun, in accordance with various aspects of the present disclosure.

FIG. 4 is a diagram illustrating an example of a weld spatter, in accordance with various aspects of the present disclosure.

FIG. 5 is a chart illustrating an example of a resistance curve, in accordance with various aspects of the present disclosure.

FIG. 6 is a chart illustrating an example of a resistance curve, in accordance with various aspects of the present disclosure.

FIG. 7 is a flow diagram illustrating an example process for weld spatter classification and root cause prediction, in accordance with some aspects of the present disclosure.

### DETAILED DESCRIPTION

The detailed description set forth below and in Appendix A, in connection with the appended drawings, is intended as a description of various configurations and is not intended to represent the only configurations in which the concepts described herein may be practiced. The detailed description include specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts.

Based on the teachings, one skilled in the art should appreciate that the scope of the present disclosure is intended to cover any aspect of the present disclosure, whether implemented independently of or combined with any other aspect of the present disclosure. For example, an apparatus may be implemented, or a method may be practiced using any number of the aspects set forth. In addition, the scope of the present disclosure is intended to cover such an apparatus or method practiced using other structure, functionality, or structure and functionality in addition to, or other than the various aspects of the present disclosure set forth. It should be understood that any aspect of the present disclosure may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the present disclosure. Although some benefits and advantages of the preferred aspects are mentioned, the scope of the present disclosure is not intended to be limited to particular benefits, uses, or objectives. Rather, aspects of the present disclosure are intended to be broadly applicable to different technologies, system configurations, networks, and protocols, some of which are illustrated by way of example in the figures and in the following description of the preferred aspects. The detailed description and the drawings are merely illustrative of the present disclosure rather than limiting, the scope of the present disclosure being defined by the appended claims and equivalents thereof.

As discussed, during the resistance spot welding process, molten steel may be ejected from the welding area, resulting in weld spatter. Weld spatter poses significant risks to both the safety and the integrity of welded joints. Weld spatter may be the result of several factors, such as welding too close to an edge of a workpiece, welding at an incorrect angle, misalignment of one or more welding tips, or using worn tips. These conditions disrupt the welding process, leading to the formation of spatter, which not only creates a potential hazard but may also compromise the strength and durability of the weld.

In most cases, a vehicle may contain approximately 5,000 spot welds, the presence of spatter can have a cumulative and detrimental effect on the overall safety and/or structural integrity of the vehicle. Reducing the incidence of weld spatter may improve the vehicle's strength and safety. In most cases, maintenance is scheduled on a regular basis to prevent weld spatter. However, conventional maintenance activities are reactive and scheduled without real-time insights. Maintenance teams typically replace certain components of welding machines at regular intervals, but given the vast number of machines in use, maintenance personnel lacked the ability to pinpoint which machines needed attention in real-time, where spatter was occurring most frequently, and what was causing it.

Various aspects of the present disclosure are directed to identifying spot welding robots (e.g., machines) responsible for producing the most spatter. In some aspects of the present disclosure, a comprehensive system integrates both data collection and machine learning to analyze and detect various aspects of weld spatter, including its nature, severity, frequency, and root causes. By pinpointing the specific machines or welding stations with high spatter rates, maintenance crews can investigate the underlying causes—whether they are related to equipment misalignment, wear and tear, or incorrect welding parameters—and take corrective actions. This targeted approach to spatter management maintains the quality of welds but also contributes to the overall safety and reliability of the finished vehicle.

In some examples, a proprietary dataset is developed to train a machine learning model to classify whether weld spatter has occurred and predict a root cause of that spatter. To train the model, some aspects of the present disclosure induced various spatter conditions by misaligning robots or altering their operation in controlled ways. Other aspects are directed to feature engineering, treating weld spatter classification and prediction as an unsupervised clustering problem. By clustering the data based on patterns without predefined labels, various aspects of the present disclosure identify novel insights into the underlying causes of spatter.

In some examples, testing may be performed in a controlled environment to induce various spatter conditions. In some such examples, weld coupons, which are two pieces of metal stacked together, were used to simulate the conditions of a car body. These coupons were used to observe the effects of different welding parameters, such as current and alignment, on spatter formation. In such examples, one or more parameters associated with electrical signals generated during the welding process were analyzed. In some such examples, resistance over time was analyzed. In cases where no spatter occurred, the resistance curve was smooth, whereas spatter events were associated with discontinuities in the resistance curve. These discontinuities provided indicators of spatter. In some examples, signals are extracted from these time series curves, and methodologies, such as Fourier transforms and spectral analysis, may be applied to identify patterns and features associated with spatter events. As such, in some examples, unsupervised clustering and advanced signal processing techniques may be used for spatter classification and prediction, thereby improving the quality and safety of welded joints in automotive manufacturing.

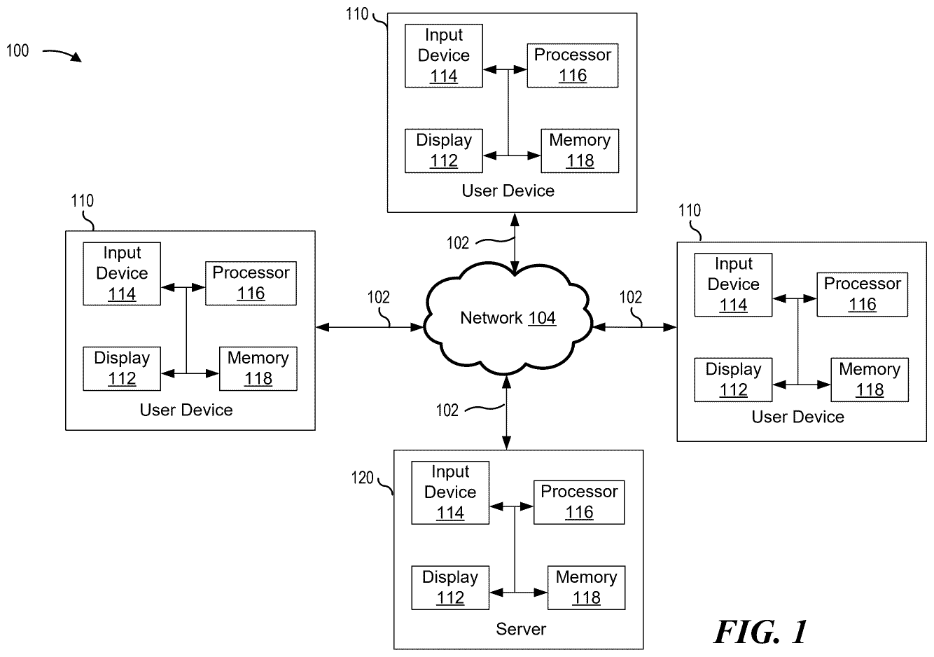

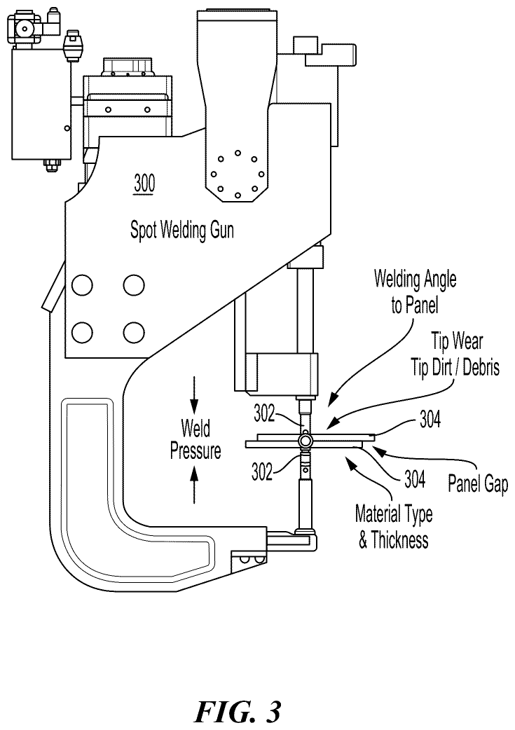

FIG. 1 is a block diagram illustrating an example of a system 100 for weld spatter analysis, in accordance with aspects of the present disclosure. As shown in the example of FIG. 1, the system 100 may include one or more user devices 110 and one or more servers 120. The user devices 110 may be examples of a welding gun 300 described with reference to FIG. 3. For ease of explanation, only one server 120 is shown in the example of FIG. 1. Each user device 110 may be connected to a network 104 via one or more communication links 102. The communication links 102 may be wired and/or wireless communication links. The server 120 may also be connected to the network 104 via a communication link 102.

The network 104 may be an example of the Internet. Additionally, or alternatively, the network 104 may include any suitable computer network such as an intranet, a wide-area network (WAN), a local-area network (LAN), a wireless network, a digital subscriber line (DSL) network, a frame relay network, an asynchronous transfer mode (ATM) network, and/or a virtual private network (VPN). The communication links 102 may be any type of communication link that may be suitable for communicating data between user devices 110 and the server 120. For example, the communication links 102 may include one or more of network links, dial-up links, wireless links (e.g., Wi-Fi link, satellite link, or cellular communication link), and/or hard-wired links.

The server 120 may be a computing device, such as a server, processor, computer, cloud computing device, cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to host a weld spatter model, a spot weld model, and/or other types of machine learning models, and communicate via a wireless or wired medium. In some examples, the server 120 may host the weld spatter model, the spot weld model, and/or other types of machine learning models. In some such examples, one or more server 120 may work in tandem to host the weld spatter model, the sport weld model, and/or other types of machine learning models. Specifically, the server 120 may implement functions and/or computer code that runs the weld spatter model, the spot weld model, and/or other types of machine learning models.

Each user device 110 may be an example of a welding gun 300, or another device, such as a smart meter/sensor, industrial manufacturing equipment, or any other suitable device that is configured to communicate via a wireless or wired medium. In some examples, each user device 110 shown in FIG. 1 may be used by a different user. Each user device 110 and server 120 may be stationary or mobile.

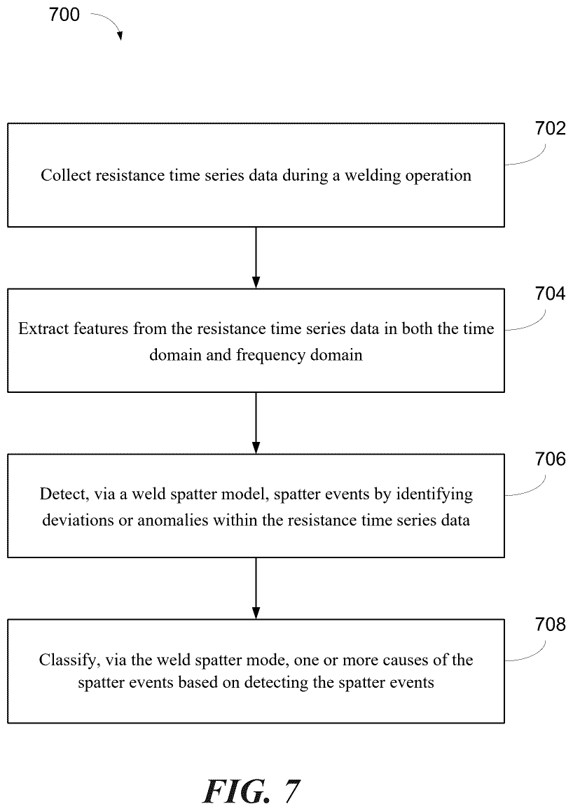

In some examples, each user device 110 may be included inside a housing that houses components of the user device 110, such as one or more processors 116 and a memory 118. The housing may also include, or be connected to, a display 112 and an input device 114, which may be interconnected with other components of the user device 110. For ease of explanation, only one processor 116 is shown for each user device 110. In some examples, the one or more processors 116, the display 112, the input device 114, and the memory 118 may be interconnected via a bus architecture. The memory 118 may include one or more different types of memory, such as random access memory (RAM), static RAM (SRAM), dynamic RAM (DRAM), and/or another type of memory. Each user device 110 may also include a storage device (not shown in the example of FIG. 1), such as a hard disk (e.g., non-transitory computer readable medium). In some examples, the memory 118 and/or the storage device include program code (e.g., instructions) that may be executed by the processor 116 to control one or more functions of the user device 110. The input device 114 may be used to navigate the interface associated with the surrogate model, and/or perform other tasks. Working in conjunction with one or more components of the user device 110, the processor 116 may receive information associated with the weld spatter model and/or other types of machine learning models, and control the display 112 to output information associated with the one or more models. The display 112 may output (e.g., display) information received at the processor 116. In some examples, the processor 116 of the user device 110 is configured to perform operations and implement one or more elements associated with one or more processes, such as the process 700 described with respect to FIG. 7.

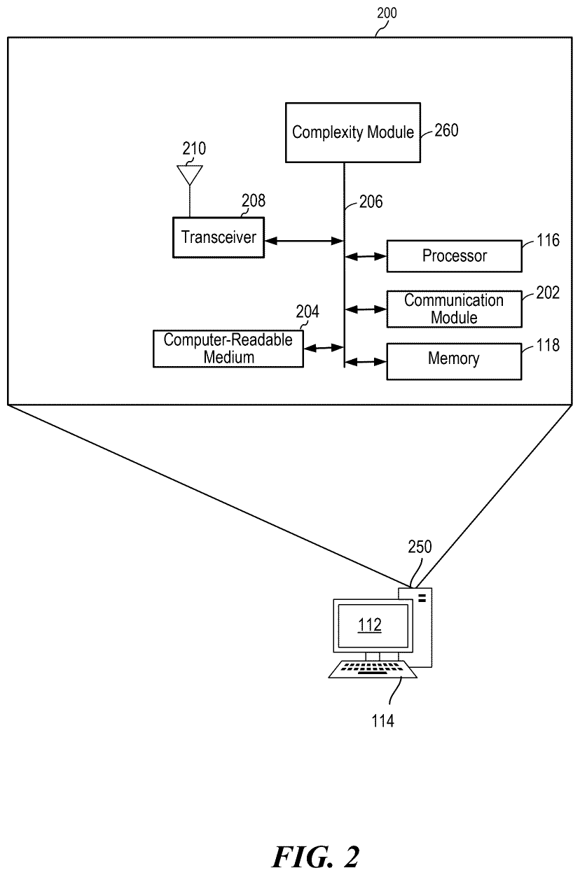

In some examples, a server 120 may be included inside a housing that houses components of the server 120, such as one or more processors 116 and a memory 118. The housing may also include, or be connected to, a display 112 and an input device 114, which may be interconnected with other components of the user device 110. For ease of explanation, only one processor 116 is shown for the server 120. In some examples, the one or more processors 116, the display 112, the input device 114, and the memory 118 may be interconnected via a bus architecture. The memory 118 may include one or more different types of memory, such as RAM, SRAM, DRAM, and/or another type of memory. The server 120 may also include a storage device (not shown in the example of FIG. 1), such as a hard disk (e.g., non-transitory computer readable medium). In some examples, the memory 118 and/or the storage device include program code (e.g., instructions) that may be executed by the processor 116 to control one or more functions of the server 120. For example, the processor 120 may execute instructions for maintaining the weld spatter model and/or other types of machine learning models, training the weld spatter model and/or other types of machine learning models, and/or executing the weld spatter model and/or other types of machine learning models. In some examples, the processor 116 of the server 120 is configured to perform operations and implement one or more elements associated with one or more processes, such as the process 700 described with respect to FIG. 7. Additionally, or alternatively, the processor 116 of the server 120 may be configured to perform operations associated with the weld spatter module 260 described with reference to FIG. 2.

FIG. 2 is a diagram illustrating an example of a hardware implementation for a system 200, according to various aspects of the present disclosure. The system 200 may be a component of a device 250. The device 250 may be an example of a user device 110 or a server 120 described with reference to FIG. 1. As shown in the example of FIG. 2, the device 250 may include a display 112 and an input device 114 (e.g., a keyboard). In some examples, the system 200 is configured to perform operations and implement one or more elements associated with one or more processes, such as the process 700 described with respect to FIG. 7.

The system 200 may be implemented with a bus architecture, represented generally by a bus 206. The bus 206 may include any number of interconnecting buses and bridges depending on the specific application of the system 200 and the overall design constraints. The bus 206 links together various circuits including one or more processors and/or hardware modules, represented by a processor 116, and a communication module 202. The bus 206 may also link various other circuits such as timing sources, peripherals, voltage regulators, and power management circuits, which are well known in the art, and therefore, will not be described any further.

The system 200 includes a transceiver 208 coupled to the processor 116, the communication module 202, and the computer-readable medium 204. The transceiver 208 is coupled to an antenna 210. The transceiver 208 communicates with various other devices over a transmission medium, such as a communication link 102 described with reference to FIG. 1. For example, the transceiver 208 may receive commands via transmissions from a user or a remote device.

As shown in the example of FIG. 2, the system 200 may include a weld spatter module 260 that may be trained to perform one or more tasks associated with detecting and/or classifying spatter events in a resistance spot welding process. In some examples, the weld spatter module 260 may implement (e.g., execute) a weld spatter model. For example, the weld spatter module 260 may be trained to perform the tasks described with reference to the one or more modules, machine learning models, and/or engines described with reference to FIG. 7. The weld spatter module 260 may include artificial or computational intelligence elements, such as, neural network, fuzzy logic, or other machine learning algorithms. In one or more arrangements, one or more of the other modules 116, 118, 202, 204, 208, can also include artificial or computational intelligence elements, such as, neural network, fuzzy logic, or other machine learning algorithms. Further, in one or more arrangements, one or more of the modules 116, 118, 202, 204, 208 can be distributed among multiple modules 116, 118, 202, 204, 208, 260 described herein. In one or more arrangements, two or more of the modules 116, 118, 202, 204, 208, 260 of the system 200 can be combined into a single module.

The system 200 includes the processor 116 coupled to the computer-readable medium 204. The processor 116 performs processing, including the execution of software stored on the computer-readable medium 204 providing functionality according to the disclosure. The software, when executed by the processor 116, causes the system 200 to perform the various functions described for a particular device, such as any of the modules 116, 118, 202, 204, 208, 260. For example, when executed by the processor 116, the software causes the system 200 and/or the weld spatter module 260 to implement one or more elements associated with one or more processes, such as the process 700 described with respect to FIG. 7. The computer-readable medium 204 may also be used for storing data that is manipulated by the processor 116 when executing the software. For example, working in conjunction with one or more of the other modules the modules 116, 118, 202, 204, and 208, the weld spatter module 260 may perform one or more operations, such as the operations of the process 700 described with reference to FIG. 7.

In some examples, the system 200 may include one or more of the modules 116, 118, 202, 204, 208, and 260 described with reference to FIG. 2. For example, the system 200 may include one or more processors 116 and one or more memories 118.

As indicated above, FIGS. 1 and 2 are provided as examples. Other examples may differ from what is described with regard to FIGS. 1 and 2.

As discussed, various aspects of the present disclosure are directed to identifying spot welding robots (e.g., machines) responsible for producing the most spatter. In some aspects of the present disclosure, a comprehensive system integrates both data collection and machine learning to analyze and detect various aspects of weld spatter, including its nature, severity, frequency, and root causes. By pinpointing the specific machines or welding stations with high spatter rates, maintenance crews can investigate the underlying causes—whether they are related to equipment misalignment, wear and tear, or incorrect welding parameters—and take corrective actions. This targeted approach to spatter management maintains the quality of welds but also contributes to the overall safety and reliability of the finished vehicle.

In some examples, a proprietary dataset is developed to train a machine learning model to classify whether weld spatter has occurred and predict a root cause of that spatter. To train the model, some aspects of the present disclosure induced various spatter conditions by misaligning robots or altering their operation in controlled ways. Other aspects are directed to feature engineering, treating weld spatter classification and prediction as an unsupervised clustering problem. By clustering the data based on patterns without predefined labels, various aspects of the present disclosure identify novel insights into the underlying causes of spatter.

In some examples, testing may be performed in a controlled environment to induce various spatter conditions. In some such examples, weld coupons, which are two pieces of metal stacked together, were used to simulate the conditions of a car body. These coupons were used to observe the effects of different welding parameters, such as current and alignment, on spatter formation. In such examples, one or more parameters associated with electrical signals generated during the welding process were analyzed. In some such examples, a resistance over time was analyzed. In cases where no spatter occurred, the resistance curve was smooth, whereas spatter events were associated with discontinuities in the resistance curve. These discontinuities provided indicators of spatter. In some examples, signals are extracted from these time series curves, and methodologies, such as Fourier transforms and spectral analysis, may be applied to identify patterns and features associated with spatter events. As such, in some examples, unsupervised clustering and advanced signal processing techniques may be used for spatter classification and prediction, thereby improving the quality and safety of welded joints in automotive manufacturing.

FIG. 3 is a diagram illustrating an example of a welding gun 300, in accordance with various aspects of the present disclosure. The welding gun 300 may perform spot welding to join metal pieces 304 (e.g., metal sheets) together. The spot welding may also be referred to as resistance spot welding. Spot welding involves clamping two or more overlapping metal pieces between electrodes 302, such as copper alloy electrodes, which apply both pressure and an electrical current to form a weld at the contact points. The electrical current generates heat due to the resistance of the metal pieces, causing the metal at the contact points to melt and form a weld nugget. As the electrodes maintain pressure, the molten metal solidifies, creating a strong bond between the sheets 304. Specifically, the pressure exerted by the electrodes 302, known as weld pressure, is crucial for creating a strong bond; improper pressure can result in poor weld quality. The angle at which the welding gun 300 approaches the sheets 304, referred to as the welding angle, is also a factor in the welding process. An improper angle may lead to uneven heat and pressure distribution, causing defects, such as weld spatter.

The condition of the welding tips is also a factor in the welding process. Over time, these tips can wear down, accumulate dirt, or collect debris, which can compromise the consistency of the weld. Worn or dirty tips may result in uneven pressure and inconsistent electrical contact, leading to defects. Additionally, the gap between the metal sheets 304, referred to as the panel gap, should be monitored, as an incorrect gap can cause weak welds or excessive spatter due to improper fusion. Lastly, the type and thickness of the materials being welded may cause weld spatter. For example, different materials and thicknesses specify different welding parameters, and incorrect settings can lead to weld spatter, weak welds, or even burn-through.

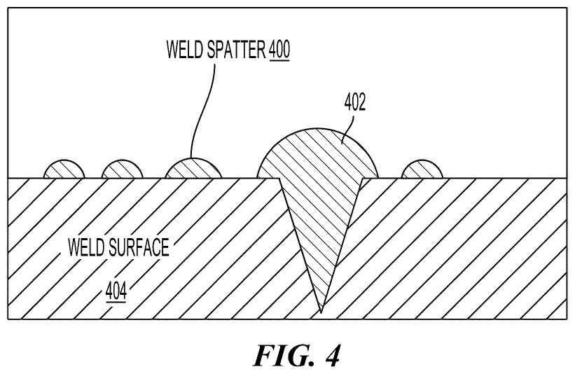

FIG. 4 is a diagram illustrating an example of a weld spatter 400, in accordance with various aspects of the present disclosure. During the spot welding process, molten steel may be ejected from the welding area 402, resulting in weld spatter 400 being deposited on a welding surface 404, such as metal or sheet metal. The metal may be steel or another type of meet. The weld splatter 400 may be a result of one or more factors, such as, but not limited to, improper welding parameters or misalignment. This weld spatter 400 is undesirable as it adheres to surrounding surfaces 404, leading to costly cleanup and potential damage to the car body. Additionally, the expelled molten steel can cause surface defects such as pitting, burns, or rough spots, which may require additional repair work or even lead to parts being scrapped. Furthermore, weld spatter 400 can affect the appearance and performance of the surface, such as the car body, impacting paint adhesion, corrosion resistance, and overall structural integrity. Therefore, it may be desirable to control and minimize weld spatter 400 to maintain quality, reduce waste, and lower production costs.

The weld surface of FIG. 4 is for illustrative purposes. For example, the wedge shown in the example of FIG. 4 is one example of a weld. In most cases, two flat sheets are welded together, such as the metal pieces 304 described with reference to FIG. 3.

To effectively identify and address the issues that contribute to weld spatter, a first step is detecting the occurrence of weld spatters (e.g., spatter events) during the welding process. Once these spatter events are accurately detected, the spatter events may be correlated with specific manufacturing conditions, such as variations in current, electrode alignment, or material properties. By establishing these correlations, aspects of the present disclosure may understand (e.g., classify or detect) one or more root causes behind the spatter. This understanding allows the system to initiate targeted corrective actions, such as adjusting welding parameters, performing maintenance on equipment, or modifying the manufacturing process to minimize or eliminate the occurrence of spatter.

In some examples, a weld spatter model, which is an example of a machine learning model, may be trained to detect spattery welds and predict weld conditions. In some examples, the weld spatter model is trained on spatter observations and/or electrical time series. The electrical time series is an example of current resistance. The training may be performed in a supervised or unsupervised manner.

Collecting data from welding guns may be challenging. For example, data collected from weld timers associated with welding may include incorrect metadata. Thus, it may be difficult to correlate collected events with real-world timestamps. This dataset was intended to correlate expulsion events with signals from the weld timers, aiming to create a model capable of reliably detecting and quantifying spatter using only the weld timer signals. As such, a ground truth dataset of weld expulsions (visually observed through cameras) may be difficult to obtain.

Therefore, in some examples, to collect data for training the weld spatter model, various welds may be performed under various controlled conditions. Each weld was performed on a coupon, which is an example of two sheets of metal (e.g., steel). During each weld, spatter observations and electrical time-series measurements (including current and resistance) may be collected. The conditions under which these welds were conducted varied, including scenarios such as nominal settings, high currents, edge welds, and tip misalignment, among others. This comprehensive dataset captures a wide range of potential variables and outcomes, providing a robust foundation for developing and training the machine learning model.

Different approaches may be used for data collection. In some examples, self-reported weld timer data may be used. In such examples, self-reported resistance, such as 120 Hz self-reported resistance, and current data directly from weld timers may be collected via proprietary software. In other examples, custom hardware may be used to collect electrical signals. In such examples, an oscilloscope with a current loop probe clamped around a primary transformer side of the weld timer may capture 1 MHz readings. This approach may provide a relatively constant-amplitude current signal that may be less accurate than the first approach as high-frequency voltage data yields a more accurate diagnosis.

In some examples, a weld timer collects resistance vs. time data for each weld. This data may be used to train the weld spatter model in an unsupervised manner. As discussed, the weld spatter model may be trained to determine whether a weld produced spatter and, second, to identify the likely root cause of that spatter. By processing the resistance data, the weld spatter model can detect anomalies indicative of spatter events and correlate them with specific conditions or equipment issues that may have caused them.

Supervised learning and unsupervised learning are different approaches in machine learning that differ primarily in how data is utilized. Supervised learning involves training a model on a labeled dataset, where each input is paired with the correct output, or label. The goal is for the model to learn the relationship between inputs and outputs so that it can accurately predict the output for new, unseen data. Supervised learning may be used for tasks, such as classification (e.g., determining if an email is spam or not) and regression (e.g., predicting house prices). In contrast, unsupervised learning works with unlabeled data, wherein the model is tasked with finding patterns, structures, or relationships within the data without explicit instructions on what the outcomes should be. Unsupervised learning may be used for various tasks, such as clustering, where the goal might be to group similar data points together, or dimensionality reduction, where the aim is to simplify the dataset while retaining its essential features.

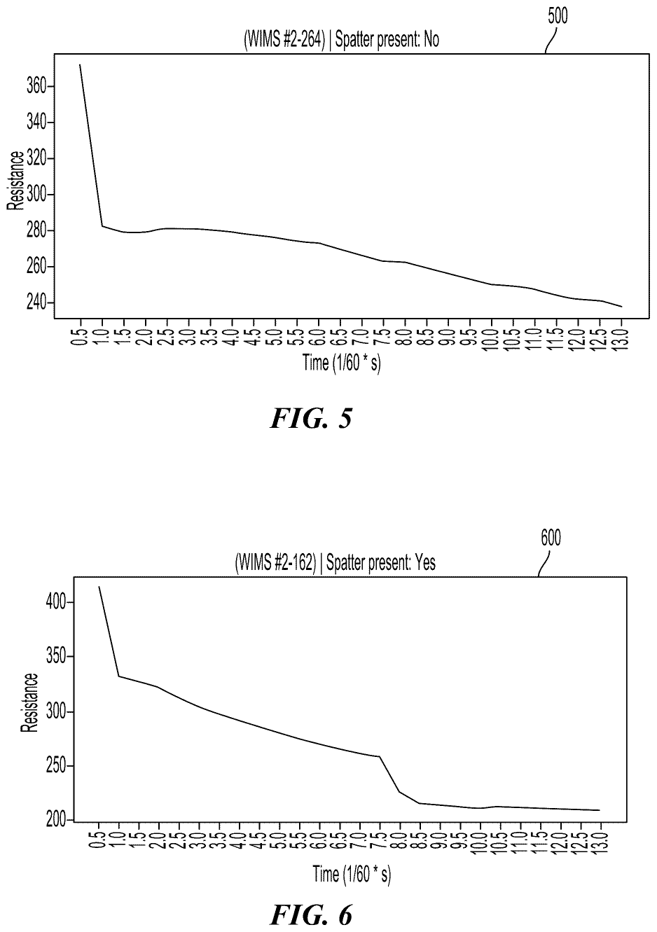

FIG. 5 is a chart illustrating an example of a resistance curve 500, in accordance with various aspects of the present disclosure. The resistance curve 500 shown in FIG. 5 represents the resistance over time during a weld where no spatter occurred. In the example of FIG. 5, the y-axis represents resistance, and the x-axis represents time. In this resistance curve 500, the resistance starts high at the beginning of the welding process. This initial high resistance is experienced based on welding electrodes making initial contact with the metal sheets, resulting in the current flowing through the contact points, which may still have some resistance due to surface irregularities or oxide layers.

As the weld progresses, the resistance drops, which indicates that the contact between the metal sheets has improved as the heat generated by the electrical current causes the metal surfaces to fuse together. This decrease in resistance is expected because the molten metal creates a better conductive path between the sheets, reducing resistance.

After the initial drop, the resistance continues to gradually decrease. This gradual decline suggests that the welding process is stable, with the metal continuing to fuse without disruptions. The absence of sharp spikes or irregularities in the curve indicates that there were no sudden changes in the weld conditions, such as spatter events, which may cause noticeable fluctuations in the resistance.

FIG. 6 is a chart illustrating an example of a resistance curve 600, in accordance with various aspects of the present disclosure. The resistance curve 600 shown in FIG. 6 represents the resistance over time during a weld where spatter occurred. In the example of FIG. 5, the y-axis represents resistance, and the x-axis represents time. As shown in the example of FIG. 6, similar to the example of FIG. 5, the resistance starts high at the beginning of the welding process as the electrodes make contact with the metal sheets. The resistance then drops as the welding progresses, indicating improved contact between the metal sheets as they begin to fuse together.

However, in contrast to the smooth decline observed in a weld without spatter, as described with reference to FIG. 5, the resistance curve 600 shows a notable irregularity around the middle of the weld process (e.g., at time 7.5). Specifically, the resistance curve 600 includes a sharp drop in resistance followed by a brief leveling off before continuing to decline. This sudden change in the resistance curve 600 is indicative of a spatter event.

As discussed, when spatter occurs, molten metal is expelled from the weld area, which may momentarily change the contact conditions between the electrodes and the metal sheets. This change can cause a sudden decrease in resistance, as seen in the sharp dip on the resistance curve 600. The subsequent stabilization and continued decline in resistance suggest that the welding process continued after the spatter event, but the irregularity in the curve confirms that the weld was disrupted.

Based on resistance time series data, such as the resistance curves 500 and 600 described with reference to FIGS. 5 and 6, machine learning models may be trained to predict the occurrence of spatter during the welding process using only resistance time series data (e.g., resistance curve data). These machine learning models may include, but are not limited to, random forest models, and convolutional neural networks (CNNs) (including CNNs having an Inception ResNet architecture). Additionally, a root cause of a weld spatter may be determined based on resistance time series data.

Resistance versus time data may be collected for each weld from the weld timer, which continuously, or periodically, monitors the welding process. In some examples, the weld timer reports this data to a proprietary software package, where the information is stored in a database and can be accessed for further analysis. In some examples, a custom driver may allow for direct reading of the data from the weld timer without relying on proprietary software, offering a more flexible and independent process of data retrieval. Once the resistance versus time data is collected, the collected data may be formatted as a vector and passed into a machine learning classifier (e.g., weld spatter model). The weld spatter model may then determine whether the weld produced spatter, which may be determined by detecting specific patterns or anomalies in the resistance curve. Additionally, or alternatively, if spatter is detected, the weld spatter model then identifies the likely root cause by correlating resistance patterns with known welding conditions or issues such as electrode misalignment, worn tips, or improper current levels. This process enables automated, real-time monitoring of welding quality, allowing for precise spatter detection and actionable root cause analysis, thereby improving production efficiency and maintenance accuracy.

Training a machine learning model in an unsupervised manner using resistance time series data involves several steps aimed at discovering patterns or structures within the resistance time series data without relying on labeled data. The process begins with data collection, where resistance time series data is gathered from multiple welding operations under various conditions. For example, as discussed, the data may be gathered based on weld information gathered from welding a number of coupons. This resistance time series may be normalized to ensure consistency across samples. Feature extraction follows, where relevant time-domain and frequency-domain features are derived from the time series data. The time-domain features may be extracted using statistical measures such as mean, variance, skewness, and kurtosis, as well as signal characteristics, such as peak values, zero-crossing rates, and/or trends over time. Additionally, the time series data may be converted into the frequency domain using techniques, such as Fast Fourier Transform (FFT). The frequency-domain conversion may identify periodic components or frequency-related anomalies that may correlate with spatter events.

In some examples, a spectral analysis may be performed to extract features related to the power spectrum, which could help identify the underlying processes influencing the resistance changes over time. Additionally, or alternatively, windowing techniques may be used to capture local patterns. Additionally, or alternatively, dimensionality reduction methods, such as principal component analysis (PCA) or t-distributed stochastic neighbor embedding (t-SNE), may be used to simplify the time series data and make it easier to identify patterns.

Next, an appropriate unsupervised learning function is selected, such as K-means clustering, density-based spatial clustering of applications with noise (DBSCAN), or hierarchical clustering for grouping similar data points, or anomaly detection functions, such as isolation forest or one-class SVM for identifying unusual patterns. K-means clustering groups data points into a predefined number of clusters based on their features. DBSCAN may identify clusters of varying shapes and densities and may identify outliers as noise. Hierarchical clustering builds a tree of clusters based on distance metrics.

The weld spatter model may then be trained on the prepared data, with hyperparameters adjusted to optimize performance, in accordance with the selected unsupervised learning function. Since unsupervised learning lacks labeled data for direct validation, the output of the weld spatter model is evaluated by examining the consistency and interpretability of the clusters or anomalies it identifies.

Once trained, the results of the weld spatter model may be interpreted to determine if the clusters or anomalies correspond to meaningful patterns in the welding process, such as different welding conditions or spatter events. This interpretation informs further data collection and model refinement. After validation, the weld spatter model can be deployed in a real-time monitoring system to continuously analyze resistance time series data, flagging potential spatter events or other issues. Integration with maintenance systems allows for automated alerts and data-driven decision-making, enabling proactive maintenance and quality control. This iterative process may be used to adapt the weld spatter model over time, improving the efficiency and reliability of welding operations.

FIG. 7 is a flow diagram illustrating an example process 700 for weld spatter classification and root cause prediction, in accordance with some aspects of the present disclosure. The process 700 may be performed by a weld spatter module 260 described with reference to FIG. 2. As shown in FIG. 7, the process 700 begins at block 702 by collecting resistance time series data during a welding operation. At block 704, the process 700 extracts features from the resistance time series data in both the time domain and frequency domain. Extracting the features includes calculating time-domain features including one or more of mean, variance, skewness, or kurtosis of the resistance time series data, performing a Fast Fourier Transform (FFT) to convert the resistance time series data into the frequency domain, and extracting frequency-domain features including the power spectrum and dominant frequencies.

At block 706, the process 700 detects, via a weld spatter model, spatter events by identifying deviations or anomalies within the resistance time series data. The weld spatter model may be trained in a unsupervised manner to identify patterns or clusters based on the extracted features. The clusters may include K-Means clusters, density-based spatial clusters of applications with noise (DBSCAN), or hierarchical clusters. At block 708, the process 700 classifies, via the weld spatter mode, one or more causes of the spatter events based on detecting the spatter events. The one or more causes may include one or more of electrode misalignment, electrode wear, material type and/or thickness, or variations in welding current.

In some examples, the process 700 includes training the weld spatter model in the unsupervised manner to identify the patterns or the clusters based on the extracted features. The training includes applying a dimensionality reduction technique to the extracted features before the training. The dimensionality reduction technique includes principal component analysis (PCA) or t-distributed stochastic neighbor embedding (t-SNE). The weld spatter model may be trained in an unsupervised manner to detect anomalies based on deviations in the resistance time series data

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a processor configured to perform the functions discussed in the present disclosure. The processor may be a neural network processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. The processor may be a microprocessor, controller, microcontroller, or state machine specially configured as described herein. A processor may also be implemented as a combination of computing devices, e.g., a combination of a DSP and a microprocessor, a plurality of microprocessors, one or more microprocessors in conjunction with a DSP core, or such other special configuration, as described herein.

The steps of a method or algorithm described in connection with the present disclosure may be embodied directly in hardware, in a software module executed by a processor, or in a combination of the two. A software module may reside in storage or machine-readable medium, including random access memory (RAM), read only memory (ROM), flash memory, erasable programmable read-only memory (EPROM), electrically erasable programmable read-only memory (EEPROM), registers, a hard disk, a removable disk, a CD-ROM or other optical disk storage, magnetic disk storage or other magnetic storage devices, or any other medium that can be used to carry or store desired program code in the form of instructions or data structures and that can be accessed by a computer. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and processing, including the execution of software stored on the machine-readable media. Software shall be construed to mean instructions, data, or any combination thereof, whether referred to as software, firmware, middleware, microcode, hardware description language, or otherwise.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or specialized register files. Although the various components discussed may be described as having a specific location, such as a local component, they may also be configured in various ways, such as certain components being configured as part of a distributed computing system.

The processing system may be configured with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functions described throughout this present disclosure. Those skilled in the art will recognize how best to implement the described functionality for the processing system depending on the particular application and the overall design constraints imposed on the overall system.

The machine-readable media may comprise a number of software modules. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a special purpose register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any storage medium that facilitates transfer of a computer program from one place to another. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means, such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A method for detecting spatter events in a resistance spot welding process, comprising:
collecting resistance time series data during a welding operation;
extracting features from the resistance time series data in both the time domain and frequency domain;
detecting, via a weld spatter model, spatter events by identifying deviations or anomalies within the resistance time series data, the weld spatter model having been trained in an unsupervised manner to identify patterns or clusters based on the extracted features; and
classifying, via the weld spatter mode, one or more causes of the spatter events based on detecting the spatter events.

2. The method of claim 1, further comprising training the weld spatter model in the unsupervised manner to identify the patterns or the clusters based on the extracted features.

3. The method of claim 2, wherein:
training the weld spatter model comprising applying a dimensionality reduction technique to the extracted features before the training; and
the dimensionality reduction technique includes principal component analysis (PCA) or t-distributed stochastic neighbor embedding (t-SNE).

4. The method of claim 2, further comprising training the weld spatter model in an unsupervised manner to detect anomalies based on deviations in the resistance time series data.

5. The method of claim 1, wherein extracting the features comprises:
calculating time-domain features including one or more of mean, variance, skewness, or kurtosis of the resistance time series data;
performing a Fast Fourier Transform (FFT) to convert the resistance time series data into the frequency domain; and
extracting frequency-domain features including the power spectrum and dominant frequencies.

6. The method of claim 1, wherein the clusters includes K-Means clusters, density-based spatial clusters of applications with noise (DBSCAN), or hierarchical clusters.

7. The method of claim 1, wherein the one or more causes include one or more of electrode misalignment, electrode wear, material type and/or thickness, or variations in welding current.

8. An apparatus for detecting spatter events in a resistance spot welding process, comprising:
one or more processors; and
one or more memories coupled with the one or more processors and storing processor-executable code that, when executed by the one or more processors, is configured to cause the apparatus to:
collect resistance time series data during a welding operation;
extract features from the resistance time series data in both the time domain and frequency domain;
detect, via a weld spatter model, spatter events by identifying deviations or anomalies within the resistance time series data, the weld spatter model having been trained in an unsupervised manner to identify patterns or clusters based on the extracted features; and
classify, via the weld spatter mode, one or more causes of the spatter events based on detecting the spatter events.

9. The apparatus of claim 8, wherein execution of the processor-executable code further causes the apparatus to train the weld spatter model in the unsupervised manner to identify the patterns or clusters based on the extracted features.

10. The apparatus of claim 9, wherein:
training the weld spatter model comprising applying a dimensionality reduction technique to the extracted features before the training; and
the dimensionality reduction technique includes principal component analysis (PCA) or t-distributed stochastic neighbor embedding (t-SNE).

11. The method of claim 9, wherein execution of the processor-executable code further causes the apparatus to train the weld spatter model in an unsupervised manner to detect anomalies based on deviations in the resistance time series data.

12. The apparatus of claim 8, wherein execution of the processor-executable code to extract the features further causes the apparatus to:
calculate time-domain features including one or more of mean, variance, skewness, or kurtosis of the resistance time series data;
perform a Fast Fourier Transform (FFT) to convert the resistance time series data into the frequency domain; and
extract frequency-domain features including the power spectrum and dominant frequencies.

13. The apparatus of claim 8, wherein the clusters includes K-Means clusters, density-based spatial clusters of applications with noise (DBSCAN), or hierarchical clusters.

14. The apparatus of claim 8, wherein the one or more causes of the spatter events include one or more of electrode misalignment, electrode wear, material type, material thickness, or variations in welding current.

15. A non-transitory computer-readable medium having program code recorded thereon for detecting spatter events in a resistance spot welding process, program code executed by one or more processors and comprising:
program code to collect resistance time series data during a welding operation;
program code to extract features from the resistance time series data in both the time domain and the frequency domain;
program code to detect spatter events via a weld spatter model by identifying deviations or anomalies within the resistance time series data, the weld spatter model having been trained in an unsupervised manner to identify patterns or clusters based on the extracted features; and
program code to classify one or more causes of the spatter events based on detecting the spatter events.

16. The non-transitory computer-readable medium of claim 15, wherein the program code further comprises program code to train the weld spatter model in the unsupervised manner to identify patterns or clusters based on the extracted features.

17. The non-transitory computer-readable medium of claim 16, wherein:
training the weld spatter model comprising applying a dimensionality reduction technique to the extracted features before the training; and
the dimensionality reduction technique includes principal component analysis (PCA) or t-distributed stochastic neighbor embedding (t-SNE).

18. The non-transitory computer-readable medium of claim 15, wherein the program code to extract the features further comprises:
program code to calculate time-domain features including one or more of mean, variance, skewness, or kurtosis of the resistance time series data;
program code to perform a Fast Fourier Transform (FFT) to convert the resistance time series data into the frequency domain; and
program code to extract frequency-domain features including the power spectrum and dominant frequencies.

19. The non-transitory computer-readable medium of claim 14, wherein the clustering includes K-Means clustering, density-based spatial clustering of applications with noise (DBSCAN), or hierarchical clustering.

20. The non-transitory computer-readable medium of claim 14, wherein the one or more causes include one or more of electrode misalignment, electrode wear, material type and/or thickness, or variations in welding current.
